(19) United States
(12) Patent Application Publication
(10) Pub. No.: US 2010/0325451 A1
(43) Pub. Date: Dec. 23, 2010

(54) POWER-SAVING TRIGGER-TYPE CONTROL DEVICE FOR DYNAMICALLY AND INSTANTLY VARYING FREQUENCY AND METHOD THEREOF

(76) Inventor: Chung-Hsing CHANG, Yonghe City (TW)

Correspondence Address: Muncy, Geissler, Olds & Lowe, PLLC, 4000 Legato Road, Suite 310, FAIRFAX, VA, 22033, US

(21) Appl. No.: 12/489,074

(22) Filed: Jun. 22, 2009

(51) Int. Cl. G06F 1/32; G06F 1/08

(52) U.S. Cl. 713/310; 713/502; 713/322

(57) ABSTRACT

The present invention discloses a power-saving trigger-type control device for dynamically and instantly varying frequency and a method thereof. The device comprises a signal control unit having at least two signal input terminals, a counting control unit, and a clock generator. The two signal input terminals respectively receive increment trigger actions and decrement trigger actions and then generate increment trigger signals and decrement trigger signals each counting to the same number as the corresponding trigger actions. The counting control unit counts the increment trigger signals or decrement trigger signals. The clock generator linearly increments or decrements output frequency according to the count of the increment trigger signals or decrement trigger signals. The device of the present invention further has a power controller to regulate output voltage. The present invention can dynamically and instantly vary the frequency/voltage of the system via external control actions in any case to achieve power efficiency.

### BACKGROUND OF THE INVENTION

1. Field of the Invention

The present invention relates to an overclocking/underclocking technology, particularly to a power-saving trigger-type control device for dynamically and instantly varying frequency and a method thereof, which not only can vary frequency but also can fine tune voltage.

2. Description of the Related Art

The concept of clock frequency involves the external frequency and the frequency multiplier. The external frequency refers to the overall system bus frequency. The frequency multiplier refers to the frequency multiplier factor. The frequency of CPU, i.e. the internal frequency, is equal to the product of the external frequency and the frequency multiplier factor. Sometimes, the external frequency and the frequency multiplier factor are manually configured to enable CPU to work at a higher frequency, whereby is promoted the performance of the computer. Such an operation is referred to as “overclock”.

At present, overclocking can be realized with three methods. The first one is to vary the overall system bus frequency, by which CPU communicates with the peripheral components, to increase the external frequency. The second one is to vary the frequency multiplier factor to increase the working frequency of CPU (because internal frequency=external frequency*frequency multiplier factor). The third one is to directly vary the working voltage of CPU. The core voltage of the working voltage of CPU closely correlates with the voltage of the internal operation of CPU. Therefore, overclocking usually cooperates with increasing core voltage (overvoltaging) to speed up and stabilize the operation of CPU.

No matter which one of the abovementioned methods is adopted to overclock, the frequency has to be fine tuned after a higher frequency is reached. The frequency is fine tuned by an increment of 1-2 MHz or another increment in the BIOS menu. Alternatively, the frequency may be fine tuned via using software or firmware to interrupt the program and control the clock generator in the environment of an operating system. However, such a measure is inflexible. Alternatively, the frequency may be fine tuned with hardware buttons. However, such a measure still needs firmware to control the clock generator with the program persistently interrupted. Too many interruptions would overburden the system and degrade the overall performance of the computer.

Refer to FIG. 1. In a current fine tuning technology, the value of the frequency increment is preset and stored in a register 14. When the user intends to adjust the frequency, he presses a confirm button 10. Next, the confirm button 10 sends out a signal to trigger a firmware controller 12 to read the preset value of the frequency increment from the register 14. Next, the firmware controller 12 writes the preset increment value into a clock generator 16 via SM BUS (System Management BUS) or I2C BUS to vary the frequency. However, such a measure, involving CPU and interrupting other programs, is complicated and time-consuming. Further, the measure is unable to dynamically and instantly overclock or underclock during running programs.

In a current frequency tuning technology, the motherboard has a Turbo mode. Pressing the Turbo key once can increment the initial CPU frequency by a fixed percentage, such as 3% or 5%. Pressing the Turbo key again restores the system to the initial CPU frequency. The technology can neither increment/decrement the frequency infinitely nor adjust the frequency by a smaller increment (such as 1 MHz) but can only increment the frequency by a fixed percentage.

As described above, the current frequency fine tuning is unlikely to dynamically and instantly overclock the system to achieve outperformance or outscoring in testing programs or playing games. The abovementioned Turbo method may bounce the frequency too high and crash the system in overclocking. Further, the current technologies cannot dynamically and instantly underclock to reduce power consumption. For example, when the batteries are going to be exhausted and the system is running programs needing lower CPU frequency, the frequency may be appropriately lowered to reduce power consumption of CPU and earn a longer running time of batteries. Such a function has not yet appeared in the current technologies.

For voltage scaling, the current technology is unlikely to vary the voltage dynamically, instantly and precisely via hardware, especially during frequency scaling. The current voltage scaling technology of the DC-DC power regulator uses software to vary the voltage in a BIOS or OS environment. The current technology can directly adjust the variable resistor (hardware) to vary the feedback voltage detected by the power regulator and then vary the output voltage without via software or firmware. However, the increment of voltage is hard to accurately control via adjusting a variable resistor, and too high an instantaneous voltage uprise may burn down the system.

Accordingly, the present invention proposes a power-saving trigger-type control device for dynamically and instantly varying frequency and a method thereof to overcome the abovementioned problems.

### SUMMARY OF THE INVENTION

One objective of the present invention is to provide a power-saving trigger-type control device for dynamically and instantly varying frequency and a method thereof, which can be externally controlled to linearly vary the frequency/voltage of the system instantly, whereby the user can perform frequency/voltage scaling dynamically according to the practical condition without using any software or firmware, wherefore power saving is achieved efficiently, conveniently and economically.

Another objective of the present invention is to provide a power-saving trigger-type control device for dynamically and instantly varying frequency and a method thereof, which can precisely perform underclocking/undervolting to achieve power efficiency or reduce power consumption when power is limited or insufficient.

A further objective of the present invention is to provide a power-saving trigger-type control device for dynamically and instantly varying frequency and a method thereof, which can dynamically and delicately overclock the system to operate at different frequencies according to the load of the system in running game programs.

To achieve the abovementioned objectives, the present invention discloses a power-saving trigger-type control device for dynamically and instantly varying frequency and a method thereof. The device of the present invention comprises a signal control unit having two signal input terminals, a counting control unit, and a clock generator. The two signal input terminals respectively receive increment trigger actions and decrement trigger actions from the user and then generate increment trigger signals and decrement trigger signals each counting to the same number as the corresponding trigger actions. The counting control unit counts the received increment trigger signals or decrement trigger signals. The clock generator linearly increments or decrements the frequency output to the CPU chipset according to the count of the increment trigger signals or decrement trigger signals.

The trigger-type control device of the present invention further comprises a power controller connected with the signal control unit and linearly incrementing or decrementing the output voltage according to the count of the increment trigger signals or decrement trigger signals. The power controller uses a built-in counting controller or an external counting controller to count the increment trigger signals or decrement trigger signals.

The present invention also proposes a trigger-type control method to dynamically and instantly varying frequency/voltage. The method of the present invention comprises steps:

in the frequency-increment phase, receiving trigger actions from a first signal input terminal, generating increment trigger signals counting to the same number as the trigger actions, counting the increment trigger signals to generate a first accumulated number, and linearly incrementing the output frequency with the number of increments equal to the first accumulated number; and

in the frequency-decrement phase, receiving trigger actions from a second signal input terminal, generating decrement trigger signals counting to the same number as the trigger actions, counting the decrement trigger signals to generate a second accumulated number, and linearly decrementing the output frequency with the number of decrements equal to the second accumulated number.

The method of the present invention may further comprise steps:

in the frequency-increment phase, periodically and linearly incrementing the output voltage according to the first accumulated number; and

in the frequency-decrement phase, periodically and linearly decrementing the output voltage according to the second accumulated number.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a block diagram schematically a conventional technology for varying frequency;

FIG. 2 is a block diagram schematically showing the architecture of a power-saving trigger-type control device for dynamically and instantly varying frequency according to a first embodiment of the present invention;

FIG. 3 is a block diagram schematically showing the architecture of a power-saving trigger-type control device incorporating a micro control chip for power management according to a second embodiment of the present invention;

FIG. 4 is a block diagram schematically showing the architecture of a power-saving trigger-type control device for dynamically and instantly varying frequency according to a third embodiment of the present invention;

FIG. 5 is a block diagram schematically showing the architecture of a power-saving trigger-type control device for dynamically and instantly varying voltage according to a fourth embodiment of the present invention;

FIG. 6 is a block diagram schematically showing the architecture of a power-saving trigger-type control device for dynamically and instantly varying voltage according to a fifth embodiment of the present invention; and

FIG. 7 is a diagram showing that two adjacent voltage-variation pulses are separated by a time interval of four frequency-variation pulse cycles.

### DETAILED DESCRIPTION OF THE INVENTION

The device of the present invention is controlled by the external actions of the user to dynamically vary the frequency and/or voltage of the system to instantly promote system performance or reduce power consumption.

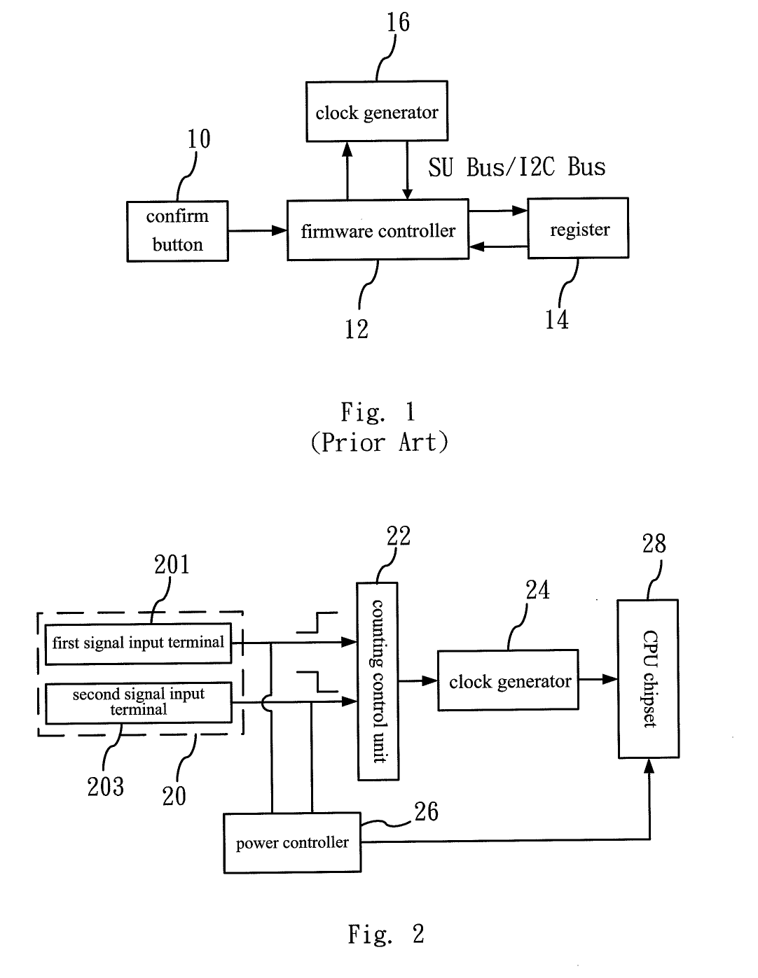

Refer to FIG. 2 a block diagram schematically showing the architecture of a power-saving trigger-type control device for dynamically and instantly varying frequency according to a first embodiment of the present invention. The device of the present invention comprises a signal control unit 20 having a first signal input terminal 201 and a second signal input terminal 203, a counting control unit 22, and a clock generator 24. The first signal input terminal 201 and second signal input terminal 203 are realized with touch control interfaces, buttons or keys. When trigger actions are applied to the first signal input terminal 201, the first signal input terminal 201 generates increment trigger signals counting to the same number as the trigger actions. When trigger actions are applied to the second signal input terminal 203, the second signal input terminal 203 generates decrement trigger signals counting to the same number as the trigger actions. The counting control unit 22 electrically connects with the signal control unit 20 and counts the received increment trigger signals or decrement trigger signals. The clock generator 24 linearly increments or decrements the frequency output to a CPU chipset 28 by a fixed frequency difference with the number of increments or decrements equal to the count of the increment trigger signals or decrement trigger signals. Alternatively, a power controller 26 is also connected to the first signal input terminal 201 and the second signal input terminal 203. The power controller 26 has a built-in counting controller or connects to an external counting controller, which counts the increment trigger signals or decrement trigger signals. The power controller 26 linearly increments or decrements the voltage output to the CPU chipset 28 by a fixed voltage difference according to the count of the increment trigger signals or decrement trigger signals.

When the first signal input terminal 201 and the second signal input terminal 203 are touched or pressed by the user simultaneously, the output frequency or output voltage is restored to the default value preset in the system. Further, a maximum frequency and a maximum voltage are also preset for the safety of the system.

The counting control unit 22 is an independent external circuit transmitting signals to the clock generator 24 or the power controller 26. Alternatively, one counting control unit 22 is built in the clock generator 24 to form a clock generation chip, and another counting control unit 22 is built in the power controller 26 to form a power control chip; thus, the clock generator 24 and the power controller 26 respectively have their own built-in counting control units 22.

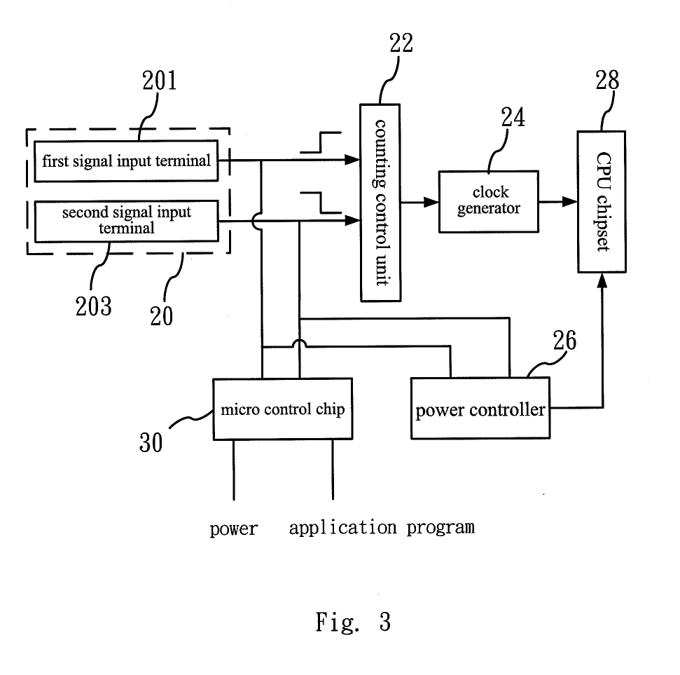

Refer to FIG. 3 a block diagram schematically showing the architecture of a power-saving trigger-type control device for dynamically and instantly varying frequency according to a second embodiment of the present invention. To effectively manage system power, particularly the power consumption of notebook computers, a micro control chip 30, such as the 8051 microcontroller, is electrically connected with the counting control unit 22. The micro control chip 30 can automatically monitor the power status of the system. When power is insufficient in the system, the micro control chip 30 automatically generates decrement trigger signals to enable the clock generator 24 to decrement the output frequency or to enable the power controller 26 to decrement the output voltage. According to the load the application program applies to the system, the micro control chip 30 may further automatically generate increment trigger signals or decrement trigger signals to enable the clock generator 24 to increment or decrement the output frequency, or to enable the power controller 26 to increment or decrement the output voltage. Thereby is reduced power consumption and achieved effective power management.

Below are described the embodiments that the power-saving trigger-type control device applies to adjusting frequency or voltage, wherein a first touch control interface and a second touch control interface respectively exemplify the first signal input terminal and the second signal input terminal, and wherein a positive edge trigger signal and a negative edge trigger signal respectively function as the increment trigger signal and the decrement trigger signal.

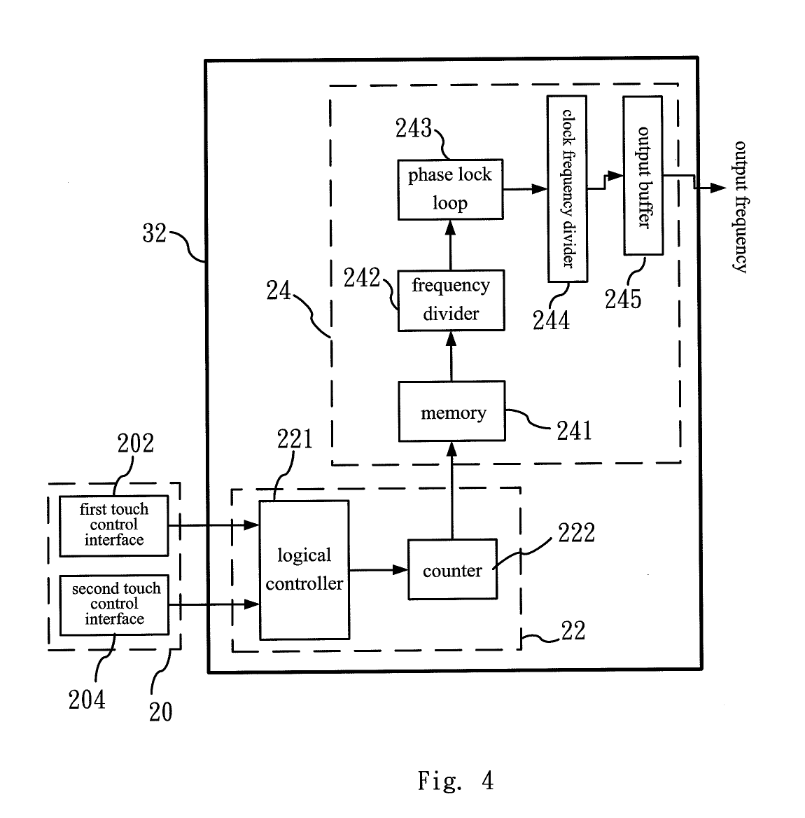

Refer to FIG. 4 a block diagram schematically showing the architecture of a power-saving trigger-type control device for dynamically and instantly varying frequency according to a third embodiment of the present invention. In this embodiment, both the counting control unit 22 and the clock generator 24 are integrated in a clock generation chip 32. The counting control unit 22 further comprises a logic controller 221 and a counter 222, wherein the logical controller 221 receives the positive edge trigger signals from a first touch control interface 202 or receives the negative edge trigger signals from a second touch control interface 204, and wherein the counter 222 is connected to the logic controller 221 and used to count the positive edge trigger signals or the negative edge trigger signals. The clock generator 24 further comprises a memory 241, a programmable frequency divider 242, a phase lock loop 243, a clock frequency divider 244, and an output buffer 245. The memory 241 stores the value of a preset output voltage and the number of the increments or decrements. The programmable frequency divider 242 varies the value (of the preset voltage) according to the number of the increments or decrements. The varied value is processed by the phase lock loop 243 and the clock frequency divider 244 and then output to the CPU chipset 28 via the output buffer 245. In addition to the circuit architecture mentioned above, the clock generator 24 may adopt another currently available circuit architecture or chip.

Below is described in detail the operation process of the trigger-type frequency control device according to the present invention.

The present invention also proposes a trigger-type control method for dynamically and instantly varying frequency. The method of the present invention comprises steps:

in the frequency-increment phase,

the first touch control interface 202 receiving trigger actions from the user and generating positive edge trigger signals, which counts to the same number as the trigger actions, to the logic control controller 221;

the counter 222 counting the positive edge trigger signals to generate a first accumulated number; and

the clock generator 24 linearly incrementing the frequency by a fixed frequency difference with the number of increments equal to the first accumulated number to output the frequency required by the user;

in the frequency-decrement phase, the second touch control interface 204 receiving trigger actions from the user and generating negative edge trigger signals, which counts to the same number as the trigger actions, to the logic control controller 221;

the counter 222 counting the negative edge trigger signals to generate a second accumulated number; and

the clock generator 24 linearly decrementing the frequency by a fixed frequency difference with the number of decrements equal to the second accumulated number to output the frequency required by the user.

In the present invention, the frequency increment or frequency decrement can be dynamically undertaken in any case to instantly meet the demand of the user.

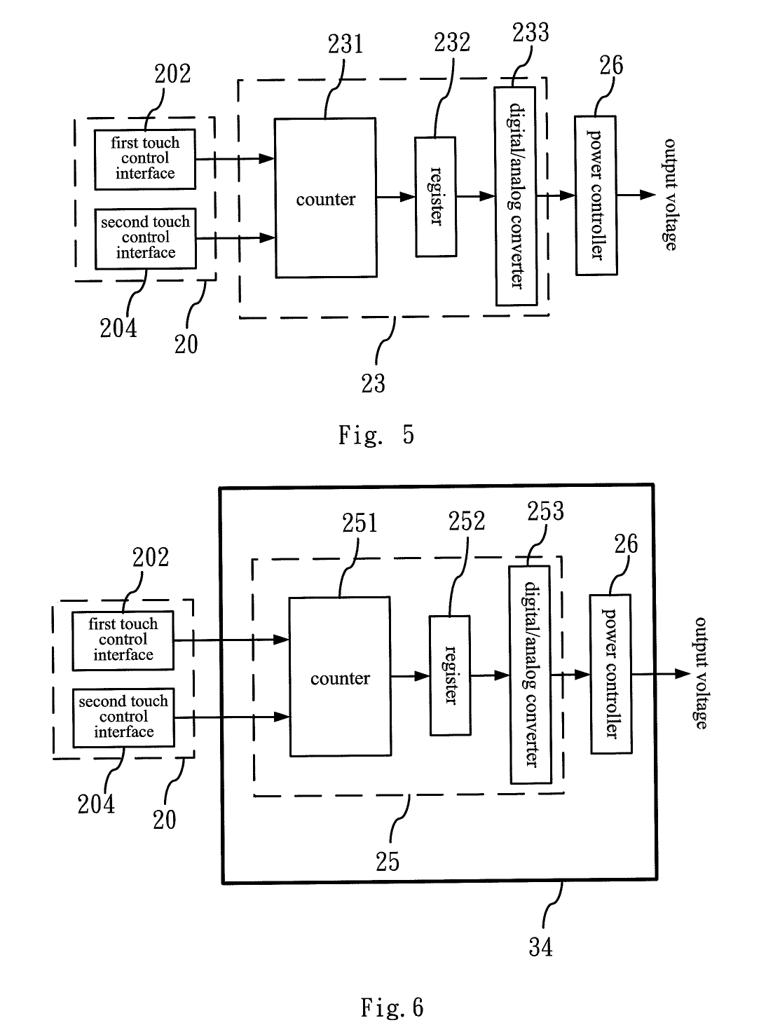

Refer to FIG. 5 a block diagram schematically showing the architecture of a power-saving trigger-type control device for dynamically and instantly varying voltage according to a fourth embodiment of the present invention. In this embodiment, the power-saving trigger-type control device further comprises an external counting controller 23 and a power controller 26. The external counting controller 23 is an independent counting controller and has a counter 231, a register 232, and a digital/analog converter 233. The counter 231 counts the positive edge trigger signals of the first touch control interface 202 or the negative edge trigger signals of the second touch control interface 204. The register 232 stores the value of a preset output voltage. The digital/analog converter 233 varies the internal reference voltage according to the number output by the counter 231 and the preset output voltage, whereby the external counting controller 23 enables the power controller 26 to linearly increment or decrement the voltage output to the CPU chipset.

Below is described in detail the operation process of the trigger-type voltage control device according to the present invention.

The present invention also proposes a trigger-type control method for dynamically and instantly varying voltage. The method of the present invention comprises steps:

in the voltage-increment phase,

the first touch control interface 202 receiving trigger actions from the user and generating positive edge trigger signals, which counts to the same number as the trigger actions, to the external counting controller 23;

the external counting controller 23 counting the positive edge trigger signals to generate a first accumulated number; and

the power controller 26 linearly incrementing the voltage by a fixed voltage difference according to the first accumulated number to output the voltage required by the user;

in the voltage-decrement phase,

the second touch control interface 204 receiving trigger actions from the user and generating negative edge trigger signals, which counts to the same number as the trigger actions, to the external counting controller 23;

the external counting controller 23 counting the negative edge trigger signals to generate a second accumulated number; and

the power controller 26 linearly decrementing the voltage by a fixed voltage difference according to the second accumulated number to output the voltage required by the user.

In the present invention, the voltage increment or voltage decrement can be dynamically undertaken in any case to instantly meet the demand of the user.

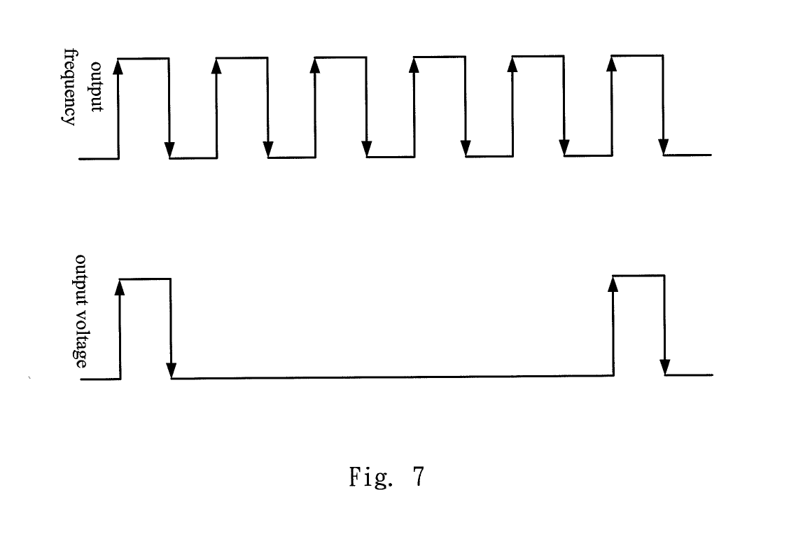

The embodiment shown in FIG. 5 is implemented with an external counting controller and the power controller. Refer to FIG. 6 a block diagram schematically showing the architecture of a power-saving trigger-type control device for dynamically and instantly varying voltage according to a fifth embodiment of the present invention. In the trigger-type voltage control device of the fifth embodiment, a counting controller 25 and the power controller 26 are integrated into a power control chip 34. The built-in counting controller 25 further comprises a counter 251, a register 252, and a digital/analog converter 253. The technical contents of the fifth embodiment shown in FIG. 6 are basically similar to that shown in FIG. 5 and will not repeat herein.

In the present invention, the power controller can cooperate with the clock generator. When the clock generator overclocks/underclocks, the power controller overvoltages/undervoltages simultaneously. However, if the clock generator overclocks by one increment and the power controller also overvoltages by one increment also, the voltage may be increased too much. For example, when the frequency is increased from 133 MHz to 233 MHz with each increment of frequency being 1 MHz, the number of increments is 100; suppose that the initial voltage is 1.5V, and that each increment of voltage is 0.01V; then, 0.01V*100=1V, thus, the resultant voltage is as high as 2.5V (=1.5V+1V) if the clock generator overclocks by one increment and the power controller also overvoltages by one increment. If the system has a highest withstand voltage of only 2.0V, it will be burnt down or overheated. Therefore, the design of voltage scaling in the present invention is that the power controller increments or decrements the output voltage once per N pieces of positive edge trigger signals or negative edge trigger signals. Refer to FIG. 2 again. For example, the clock generator 24 receives signals from the counting control unit 22 and varies the output frequency once per signal; the power controller 26 simultaneously receives signals from the signal control unit 20 but varies the output voltage once per N pieces of signals (pulse cycles). As shown in FIG. 7, two adjacent voltage-variation pulses are separated by a time interval of four frequency-variation pulse cycles.

From the above description, it is known that the present can instantly overclocks and increments the frequency infinitely until the upper limit of the clock generator is reached, neither interrupting any software/firmware nor affecting the performance of the system. Therefore, the present invention can overcome the problem of the conventional technology that hardware, firmware and bus are involved and affected in frequency/voltage scaling. Not via SM BUS, the present invention uses external hardware to directly control the clock generator or the power controller. Therefore, the present invention can directly and instantly vary the frequency and voltage of the system and features high response speed. Besides, the present invention enables the user to manually underclock and undervoltage. Therefore, the present invention can reduce the power consumption of the system dynamically and instantly and save the cost of developing firmware.

Many motherboards can be overclocked to a high point during booting the system before entering the Windows. However, the system is apt to crash during entering the Windows in such a case. Therefore, the system can be overclocked to an appropriate frequency suitable for the Windows with the existing overclocking technology during entering the Windows. Then, the system is fine tuned to have an expected frequency under the Windows environment with the external hardware of the present invention. Thereby, the system may even have a further higher frequency than before entering the Windows. Even though the system has been tuned to a high point of frequency under the Windows environment, the system is not necessarily able to execute some programs that consume much system resource. When the system executes programs, the present invention can dynamically and instantly perform frequency scaling and enable voltage scaling at the same time. Therefore, the user can flexibly manage the resource of the system via the present invention.

The embodiments described above are only to exemplify the present invention to enable the persons skilled in the art to understand, make and use the present invention. However, it is not intended to limit the scope of the present invention. Any equivalent modification or variation according to spirit of the present invention is to be also included within the scope of the present invention.

1. A power-saving trigger-type control device for dynamically and instantly varying frequency comprising
a signal control unit having two signal input terminals, wherein said two signal input terminals respectively generate increment trigger signals and decrement trigger signals each counting to a same number as corresponding trigger actions;
a counting control unit connected with said signal control unit to receive said increment trigger signals or said decrement trigger signals and counting said increment trigger signals or said decrement trigger signals; and
a clock generator linearly incrementing or decrementing output frequency according to a count of said increment trigger signals or said decrement trigger signals.

2. The power-saving trigger-type control device according to claim 1, wherein said output frequency is an external frequency of a CPU chipset.

3. The power-saving trigger-type control device according to claim 1, wherein said two signal input terminals are respectively a first signal input terminal and a second signal input terminal; said first signal input terminal generates said increment trigger signals counting to a same number as trigger actions applied to said first signal input terminal; said second signal input terminal generates said decrement trigger signals counting to a same number as trigger actions applied to said second signal input terminal.

4. The power-saving trigger-type control device according to claim 3, wherein said first signal input terminal and said second signal input terminal are touch control interfaces, buttons, or keys.

5. The power-saving trigger-type control device according to claim 3, wherein when said two signal input terminals are triggered simultaneously, said output frequency is restored to a preset value.

6. The power-saving trigger-type control device according to claim 1, wherein said counting control unit and said clock generator are integrated into an identical chip.

7. The power-saving trigger-type control device according to claim 1, wherein said counting control unit further comprises
a logic controller receiving said increment trigger signals or said decrement trigger signals from one of said signal input terminals; and
a counter connected to said logic controller and counting said increment trigger signals or said decrement trigger signals.

8. The power-saving trigger-type control device according to claim 1, wherein each time one of said increment trigger signals or said decrement trigger signals is generated, said clock generator increments or decrements said output frequency by a fixed frequency difference.

9. The power-saving trigger-type control device according to claim 1 further comprising a power controller, wherein said power controller linearly increments or decrements output voltage according to a count of said increment trigger signals or said decrement trigger signals.

10. The power-saving trigger-type control device according to claim 9, wherein said power controller increments or decrements said output voltage once in every time interval of N pieces of said increment trigger signals or said decrement trigger signals.

11. The power-saving trigger-type control device according to claim 9, wherein said power controller has a built-in counting controller.

12. The power-saving trigger-type control device according to claim 11, wherein said built-in counting controller further comprises
a counter counting said increment trigger signals or said decrement trigger signals;
a register storing a value of a preset output voltage; and
a digital/analog converter varying an internal reference voltage according to a number output by said counter and said preset output voltage, and enabling said power controller to linearly increment or decrement said output voltage.

13. The power-saving trigger-type control device according to claim 1 further comprising a power controller and an external counting controller, wherein said external counting controller connects with said signal control unit and enables said power controller to linearly increment or decrement output voltage according to a count of said increment trigger signals or said decrement trigger signals.

14. The power-saving trigger-type control device according to claim 13, wherein every time said external counting controller receives N pieces of said increment trigger signals or said decrement trigger signals, said power controller increments or decrements said output voltage once.

15. The power-saving trigger-type control device according to claim 10, wherein every time N pieces of said increment trigger signals or said decrement trigger signals are generated, said power controller increments or decrements said output voltage by a fixed voltage difference.

16. The power-saving trigger-type control device according to claim 14, wherein every time N pieces of said increment trigger signals or said decrement trigger signals are generated, said power controller increments or decrements said output voltage by a fixed voltage difference.

17. The power-saving trigger-type control device according to claim 13, wherein said external counting controller further comprises
a counter counting said increment trigger signals or said decrement trigger signals;
a register storing a value of a preset output voltage; and
a digital/analog converter varying an internal reference voltage according to a number output by said counter and said preset output voltage, and enabling said power controller to linearly increment or decrement said output voltage.

18. The power-saving trigger-type control device according to claim 9, wherein when said two signal input terminals are triggered simultaneously, said output voltage is restored to a preset value.

19. The power-saving trigger-type control device according to claim 13, wherein when said two signal input terminals are triggered simultaneously, said output voltage is restored to a preset value.

20. The power-saving trigger-type control device according to claim 1 further comprising a micro control chip, which is electrically connected to said counting control unit and automatically detects a power status of a system, wherein when power is insufficient, said micro control chip generates said decrement trigger signals to said counting control unit to enable said clock generator to automatically decrement said output frequency.

21. The power-saving trigger-type control device according to claim 1 further comprising a micro control chip electrically connected to said counting control unit, wherein said micro control chip generates to said counting control unit said increment trigger signals or said decrement trigger signals according to loads, which running programs apply to a system, to enable said clock generator to automatically increment or decrement said output frequency.

22. The power-saving trigger-type control device according to claim 1, wherein said increment trigger signals are positive edge trigger signals, and said decrement trigger signals are negative edge trigger signals.

23. A trigger-type control method for dynamically and instantly varying frequency comprising steps:
in a frequency-increment phase,
triggering a first signal input terminal, generating increment trigger signals counting to a same number as trigger actions;
counting said increment trigger signals to generate a first accumulated number; and
linearly incrementing output frequency with a number of increments equal to said first accumulated number; and
in a frequency-decrement phase,
triggering a second signal input terminal, generating decrement trigger signals counting to a same number as trigger actions;
counting said decrement trigger signals to generate a second accumulated number; and
linearly decrementing said output frequency with a number of decrements equal to said second accumulated number.

24. The trigger-type control method according to claim 23, wherein said output frequency is an external frequency of a CPU chipset.

25. The trigger-type control method according to claim 23, wherein said first signal input terminal and said second signal input terminal are touch control interfaces, buttons, or keys.

26. The trigger-type control method according to claim 23 further comprising a step of restoring said output frequency to a preset value when said first signal input terminal and said second signal input terminal are triggered simultaneously.

27. The trigger-type control method according to claim 23, wherein said output frequency is linearly incremented by a fixed frequency difference every time.

28. The trigger-type control method according to claim 23, wherein said output frequency is linearly decremented by a fixed frequency difference every time.

29. The trigger-type control method according to claim 23, wherein in said frequency-increment phase, output voltage is linearly incremented according to said first accumulated number.

30. The trigger-type control method according to claim 29, wherein said output voltage is incremented by a fixed voltage difference once for every N counts of said first accumulated number.

31. The trigger-type control method according to claim 23, wherein in said frequency-decrement phase, output voltage is linearly decremented according to said second accumulated number.

32. The trigger-type control method according to claim 31, wherein said output voltage is decremented by a fixed voltage difference once for every N counts of said second accumulated number.

33. The trigger-type control method according to claim 23, wherein said increment trigger signals are positive edge trigger signals, and said decrement trigger signals are negative edge trigger signals.
